(19) United States
(12) Patent Application Publication
(10) Pub. No.: US 2021/0300198 A1
(43) Pub. Date: Sep. 30, 2021

(54) REINFORCEMENT LEARNING-BASED ELECTRIC VEHICLE CHARGING METHOD AND SYSTEM

(71) Applicant: LG ELECTRONICS INC., Seoul (KR)

(72) Inventors: Junghwa CHOI, Seoul (KR); Minkook KIM, Seoul (KR); Yeonjung KIM, Seoul (KR); Kyungyul KIM, Seoul (KR); Sungyong YOON, Seoul (KR); Yeonho CHOI, Seoul (KR)

(73) Assignee: LG ELECTRONICS INC., Seoul (KR)

(21) Appl. No.: 17/088,140

(22) Filed: Nov. 3, 2020

(30) Foreign Application Priority Data
Mar. 31, 2020 (KR) 10-2020-0039194

(51) Int. Cl. B60L 53/62; B60L 53/66; B60L 53/30; G06N 20/00; G06Q 30/02

(52) U.S. Cl. CPC B60L 53/62; B60L 53/665; G06Q 30/0226; G06N 20/00; B60L 53/305

(57) ABSTRACT

A method for reinforcement learning-based vehicle charging can include receiving a vehicle charging request from a second vehicle while a first vehicle already exists in a charging queue and is being charged; in response to the vehicle charging request from the second vehicle, determining a charging condition of the second vehicle and determining a designated position for the second vehicle in the charging queue based on both a charging learning model generated based on records of past vehicle charging requests from the second vehicle and a charging condition of the first vehicle that is being charged; and placing the second vehicle in the charging queue according to the designated position.

### CROSS REFERENCE TO RELATED APPLICATION

The present application claims the benefit of priority to Korean Patent Application No. 10-2020-0039194, filed in the Republic of Korea on Mar. 31, 2020, the entire contents of which are incorporated by reference herein for all purposes into the present application.

### BACKGROUND OF THE INVENTION

An electric vehicle (EV) is a vehicle that uses one or more electric motors powered by a high voltage battery for propulsion thereof. High voltage batteries mounted in electric vehicles (EVs) are typically charged from external power supply equipment. Private or public EV chargers are used to charge EVs.

Public EV chargers refer to chargers that are used by a number of unspecified users. EVs in need of charging can be charged when there are available EV chargers. In a situation where all EV chargers connected to power supply equipment are occupied or a situation where an EV is being charged from an EV charger at a maximum power rate that can be delivered from the power supply equipment, other EVs have to wait until the ongoing charging is completed.

To address this problem, various techniques for managing or scheduling EV charging services have emerged.

### SUMMARY OF THE INVENTION

The present invention relates to a reinforcement learning-based electric vehicle charging method and system. More particularly, the present invention relates to a method and system for charging an electric vehicle (EV), the method and system being capable of suggesting a charging rate and a charging mode to a user based on a reinforcement learning-based EV charging service model.

An objective of the present invention is to provide an electric vehicle charging system capable of automatically proposing an electric vehicle charging mode to a user by using a vehicle charging service learning model created based on records of past charging events related to the user and capable of efficiently queuing charging sessions of respective electric vehicles.

Another objective of the present invention is to provide a method of automatically proposing an electric vehicle charging mode to a user and efficiently queuing charging sessions of respective electric vehicles by using artificial intelligence (AI) and reinforcement learning technology.

The objectives of the present invention are not limited to the ones mentioned above, and other objectives not mentioned above can be clearly understood by those skilled in the art from the following description.

In order to accomplish one objective of the present invention, according to one aspect, there is provided a reinforcement learning-based vehicle charging method including: receiving a vehicle charging request from a first vehicle which is an incoming vehicle; and in response to the vehicle charging request, determining a charging condition of the first vehicle and putting the first vehicle in a charging queue while designating a position of the first vehicle in the charging queue, using both a charging learning model generated based on records of past vehicle charging requests of the first vehicle and a charging condition of at least one second vehicle which is already in the charging queue and is currently being charged.

According to one embodiment of the present invention, the receiving of the vehicle charging request may include a receiving charging request information including a charging rate and a status of charging requested by the first vehicle.

According to one embodiment of the present invention, the determining of the charging condition of the first vehicle may include: requesting the at least one second vehicle to approve a simultaneous charging event in which the first vehicle and the second vehicle are simultaneously charged; and changing a charging condition of the at least one second vehicle depending on approval or disapproval of the user of the second vehicle.

According to one embodiment of the present invention, the changing or maintaining of the charging condition of the second vehicle may include: setting charging rates of the first and second vehicles to be equal when the second vehicle approves the simultaneous charging event; and billing a user of the first vehicle for a portion of a charging cost of the second vehicle.

According to one embodiment of the present invention, the charging learning model may be created in a manner that: an agent defines both a current state of an environment including the charging queue and an action of the first vehicle or the second vehicle; the agent receives a reward that is increased or decreased according to the action; and the agent refines the charging learning model in a way to maximize a cumulative sum of the rewards.

According to one embodiment of the present invention, the receiving of the vehicle charging request may include: determining output data to be sent to a display screen by using the charging learning model; displaying the output data on the display screen; and receiving input data with respect to the output data.

In order to achieve one objective of the present invention, according to another aspect, there is provided a reinforcement learning-based vehicle charging system including: at least one charging device to be connected to a vehicle; power supply equipment that delivers electric energy to the at least one charging device; and a charging controller that controls operation of the at least one charging device and operation of the power supply equipment. The charging device receives a vehicle charging request from a first vehicle which has just arrived. The charging controller determines a charging condition for the first vehicle and puts the first vehicle in a queue for charging while designating a position of the first vehicle in the queue in the charging queue, based on the vehicle charging request. For the determination of the charging condition, the charging controller uses a charging learning model created based on records of past charging events of the first vehicle, and a charging condition of a second vehicle that is in the charging queue and is currently being charged.

According to one embodiment of the present invention, the charging device may receive charging request information including a charging rate and a charge level to be reached through vehicle charging.

According to one embodiment of the present invention, the charging controller may request a user of the second EV to approve a simultaneous charging event in which charging of the first vehicle and charging of the second vehicle are simultaneously performed, and changes or maintains the charging condition of the second vehicle depending on approval or disapproval of the user of the second vehicle.

According to one embodiment of the present invention, when the simultaneous charging event is approved, the charging controller may set a charging rate of the first vehicle and a charging rate of the second vehicle to be equal and bill a user of the first vehicle for a portion of a charging cost of the second vehicle.

According to one embodiment of the present invention, the charging controller may cause an agent to define a current state of an environment including the charging queue and an action of the first vehicle or the second vehicle, to receive a reward that is increased or decreased according to the action, and to refine the charging learning model in a way to maximize a cumulative sum of the rewards.

According to one embodiment of the present invention, the charging controller may determine output data to be sent to a display screen by using the charging learning mode, and the charging device may display the output data on the display screen thereof and receive input data with respect to the output data.

The further details of the embodiment will be described in the following description with reference to the accompanying drawings.

Reinforcement learning-based vehicle charging methods according to exemplary embodiments of the present invention can improve user satisfaction and convenience in vehicle charging by generating a learning model for EV charging service based on records of past charging events and proposing a user-specific charging condition including a charging rate and a charging level to a user.

The effects, features, and advantages of the present invention are not limited to the ones mentioned above, and other effects, features, and advantages not mentioned above can be clearly understood by those skilled in the art from the following description.

### BRIEF DESCRIPTION OF THE DRAWINGS

FIG. 1 is a block diagram illustrating the configuration of a vehicle charging system according to one embodiment of the present invention;

FIG. 2 is a view illustrating the configuration of a charging controller according to an embodiment of the present invention;

FIG. 3 is a view illustrating the structure of a fully-connected artificial neural network according to an embodiment of the present invention;

FIG. 4 is a view illustrating the structure of a convolutional neural network (CNN) that is a class of deep neural networks according to an embodiment of the present invention;

FIG. 5 is a flowchart illustrating a vehicle charging method according to one embodiment of the present invention;

FIGS. 6 to 10 are views illustrating a charging condition setting menu for interactive charging, the menu being displayed on a display screen of a charging device included in a vehicle charging system according to embodiments of the present invention;

FIGS. 11 and 12 are tables showing the flow of vehicles in a vehicle charging system according to one embodiment of the present invention;

FIG. 13 is a flowchart illustrating a vehicle charging process when standard charging (also referred to as programmed charging) is selected as a service type in a vehicle charging system according to one embodiment of the present invention;

FIG. 14, including parts (a)-(c), is a diagram illustrating a process of creating a charging learning model in a vehicle charging system according to one embodiment of the present invention; and

FIG. 15 is a view illustrating an exemplary dialog box that is displayed on the display screen of a charging device to receive commands from a user according to an embodiment of the present invention.

### DETAILED DESCRIPTION OF THE EMBODIMENTS

Hereinbelow, example embodiments of the present invention will be described with reference to the accompanying drawings. Throughout the drawings and the detailed description of the embodiments, like components are designated by like reference numerals and a redundant description of the components will be omitted. The suffixes “module,” “part,” and “unit” used in the following description to name constituent components are given only in consideration of the ease of description, and do not have meanings or roles distinguished from each other. In describing embodiments of the present invention, when a detailed description of known technology in the related art is determined to unnecessarily obscure the gist of the present invention, the detailed description will be omitted. The accompanying drawings are provided only for helping understand the embodiments disclosed herein, and the technical spirit of the present invention is not limited by the accompanying drawings. Therefore, it should be understood that all modifications, equivalents, and substitutes to the embodiments fall within the technical scope of the present invention as claimed in the appending claims.

Terms such as a first term and a second term may be used for explaining various constitutive elements, but the constitutive elements should not be limited to these terms. That is, the terms are used to distinguish one component from another component.

It will be understood that when any element is referred to as being “connected” or “coupled” to another element, one element may be directly connected or coupled to the other element, or an intervening element may be present therebetween. In contrast, it should be understood that when an element is referred to as being “directly coupled” or “directly connected” to another element, there are no intervening elements present between them.

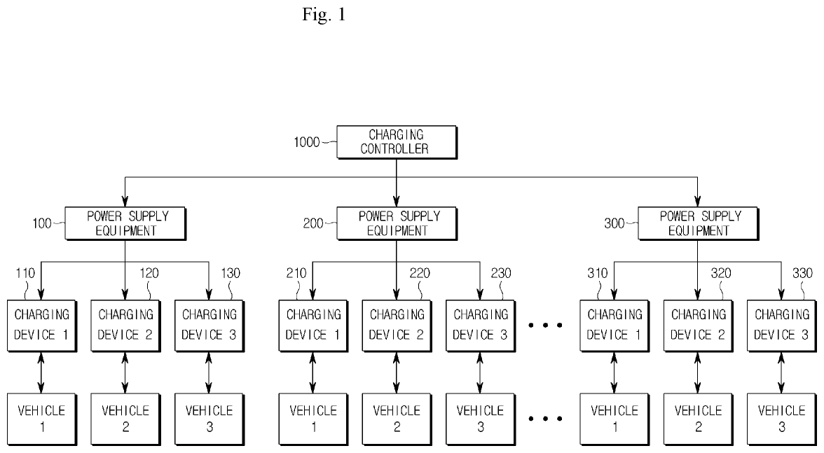

FIG. 1 is a block diagram illustrating the configuration of a vehicle charging system according to one embodiment of the present invention.

Referring to FIG. 1, a vehicle charging system according to one embodiment of the present invention includes: charging devices 110 to 130, 210 to 230, and 310 to 330 for charging electronic vehicles (EVs); power supply equipment 100, 200, and 300 that deliver electric power to the charging devices 110 to 130, 210 to 230, and 310 to 330; and a charging controller 1000 that controls operation of the power supply equipment 100, 200, and 300 and operation of the charging devices 110 to 130, 210 to 230, and 310 to 330.

The charging devices 110 to 130 are connected to electric vehicles in need of charging. Each of the charging devices 110 to 130 includes a connector (also called coupler) to be plugged into a vehicle inlet, an input unit with which a user can provide information or select commands as input data, a display unit that displays a charging condition setting menu, and an audio output unit that provides audio guidance to a user.

The charging devices 110 to 130 receive charging request information including a charging rate and a charge level to be reached through vehicle charging, from a user. When charging sessions for respective vehicles are queued, the charging controller 1000 sends a message notifying that queuing is completed to the display screens of the respective charging devices 110 to 130.

FIG. 1 illustrates an installation arrangement for a vehicle charging system. In this example, three charging devices are connected to a single piece of power supply equipment. However, the present invention is not limited thereto. That is, the number of charging devices connected to a single piece of power supply equipment may vary depending on the design of a vehicle charging system.

Each of the charging devices 110 to 130 is equipped with any type of connector among various types of connectors that comply with existing standards and which are available. Currently available connectors include CHAdeMO connectors, combined charging system (CCS) connectors (so-called Combo), and the like.

The charging devices 110 to 130 can be simultaneously supplied with electric power from the power supply equipment 1000. That is, for example, three vehicles connected to the respective charging devices 110 to 130 can be simultaneously charged from the same power supply equipment.

The charging devices 110 to 130 can deliver electric power at different charging rates to vehicles according to the state of the charging queue which is set by the charging controller 1000. A vehicle that arrives earlier is ranked a higher position in a queue for vehicle charging, and a vehicle ranked a higher position in the queue has priority for rapid charging mode. The way of setting different charging rates for vehicles according to the positions in the queue will be described below in more detail.

Each piece of power supply equipment 100, 200, and 300 delivers electric power as AC or DC power to charge vehicles. The power supply equipment 100, 200, and 300 take AC power from an electrical grid and convert it to DC power at a suitable voltage for vehicle charging. The power supply equipment 100, 200, and 300 supply DC power to the charging devices under the control of the charging controller 1000.

FIG. 1 illustrates a vehicle charging system in which three pieces of power supply equipment 100, 200, and 300 are installed. However, the present invention is not limited thereto. The number of pieces of power supply equipment included in a vehicle charging system varies depending on the design of a vehicle charging system.

The charging controller 1000 is connected to each piece of the power supply equipment 100, 200, and 300 and each of the charging devices 110 to 130, 210 to 230, and 310 to 330. The charging controller 1000 controls operation of the power supply equipment and operation of the charging devices. Specifically, the charging controller 1000 generates a charging queue in which charging sessions of respective vehicles connected to the charging devices are queued in order of arrival time and updates the charging queue when each charging session is completed. Thus, the charging sessions of the respective vehicles in the queue are rearranged in order. In addition, the charging controller 1000 creates a charging learning model based on records of past charging events of a vehicle and proposes a charging rate and a charge level to the vehicle based on the charging learning model.

The charging controller 1000 can be installed at the same site as the power supply equipment 100, 200, and 300 and the charging devices 110 to 130, 210 to 230, and 310 to 330. However, the present invention is not limited thereto. Alternatively, the charging controller 1000 may be installed in a remote site. In this case, the charging controller 1000 may communicate with the power supply equipment and the charging devices via a communication network.

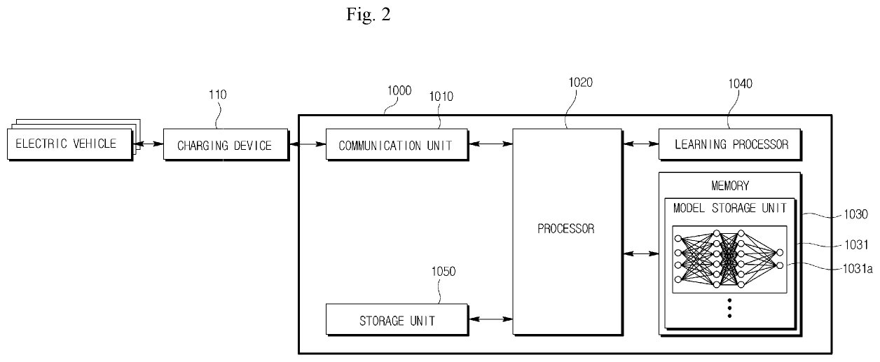

Next, a detailed construction of the charging controller 1000 will be described with reference to FIG. 2.

FIG. 2 is a view illustrating the construction of the charging controller 1000.

Referring to FIG. 2, the charging controller 1000 includes a communication unit 1010, a processor 1020, a memory 1030, a learning processor 1040, and a storage unit 1050.

The charging controller 1000 is implemented with a general-purpose computer or a server that is a collection of computers. The computer or server serving as the charging controller 1000 communicates with the charging devices and the power supply equipment via a cable communication network or a wireless communication network.

The communication unit 1010 connects the charging controller 1000 with the charging device 110 or the power supply equipment 100. The communication unit 1010 complies with a wireless or cable communication standard, thereby being connected to the charging device 110 or the power supply equipment 100 using a wireless or cable communication scheme. In addition to this connection, the communication unit 1010 can connect the charging controller 1000 with an external computing device.

The communication unit 1010 receives charging request information (hereinafter, also referred to as charging request) from the charging device 110. That is, when a certain user (hereinafter, referred to as a first user) inputs charging request information (e.g., charging request) into the charging device 110 for charging his/her vehicle (hereinafter, referred to as a first vehicle), the charging request is transferred to the communication unit 1010. When the charging controller 100 determines a charging condition (e.g., a charging rate and a charge level to be reached through vehicle charging) for the first vehicle based on the charging request, the communication unit 1010 sends a message including the charging condition (e.g., charging rate and charge level) to the charging device 110.

The communication unit 1010 obtains training data to generate a learning model from records of past charging events of the first user and obtains input data to generate output data using the learning model.

When the charging device 100 is occupied by another electric vehicle (hereinafter, referred to as a second vehicle), the communication unit 1010 sends a message of requesting a user of the second vehicle to approve a simultaneous charging event in which the first vehicle and the second vehicle are simultaneously charged. In some embodiments, when the communication unit 1010 sends a message to a terminal device, such as a mobile phone, of the user of the second vehicle that is being charged, the communication unit 1010 may use wireless communication schemes such as wireless LAN (WLAN), wireless-fidelity(Wi-Fi), high speed downlink packet access (HSDPA), high speed uplink packet access (HSDPA), long term evolution (LTE), long term evolution-advanced (LTE-A), and 5G.

The processor 1020 controls operation of the charging controller 100 according to information that is input.

The processor 1020 determines or predicts at least one possible operation of the user terminal device based on information that is determined or generated by data analysis and machine learning algorithms. To this end, the processor 1020 requests, retrieves, receives, or uses data stored in the learning processor 1040 and controls the charging controller 1000 to execute a predicted operation or an appropriate operation among the possible operations.

The processor 1020 performs various functions to implement an intelligent emulation (for example, a knowledge-based system, an inference system, and a knowledge acquisition system). This can apply to various systems (for example, fuzzy logic systems) including adaptive systems, machine learning systems, artificial neural networks, and the like.

In order to collect a massive amount of information to be processed by or saved in the learning processor 1040, the processor 1020 collects (e.g., senses, monitors, extracts, detects, receives, etc.) signals, data, information and the like in conjunction with sensing components provided in the charging controller 1000.

Particularly, collection of information may be understood as a terminology including an operation of sensing information through a sensor, extracting information stored in a memory, or receiving information from an electronic device, an entity, or an external storage device through communication.

The processor 1020 collects a massive amount of information (for example, knowledge graph, command policy, personalized database, conversation engine, etc.) in real time, processes or classifies the information, and saves the resulting information in the memory 1030 or in the learning processor 1040.

When a specific operation of the charging controller 1000 is determined by data analysis and machine learning algorithm and technology, the processor 1020 controls a constituent element of the charging controller 1000 to execute the determined operation. The processor 1020 controls the charging controller 1000 according to a control command, thereby executing the determined operation.

When once a specific operation is executed, the processor 1020 analyzes history information about the executions of the specific operation using data analysis and machine learning algorithm and technology, and updates existing training information based on the information resulting from the analysis.

Therefore, the processor 1020 can improve the accuracy and performance of the data analysis and machine learning algorithm and technology based on the updated information in conjunction with the learning processor 1040.

The memory 1030 temporarily or non-temporarily store data processed by the processor 1020. The memory 1030 may store a plurality of application programs (simply called applications) to be activated by the charging controller 1000, data necessary for operation of the charging controller 1000, instructions, and data (for example, information on at least one algorithm for machine learning) necessary for operation of the learning processor 1040.

The memory 1030 is implemented with a volatile memory or a nonvolatile memory. Examples of non-volatile memory include read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), and the like. Examples of volatile memory include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), and the like.

In a vehicle charging system according to one embodiment of the present invention, the memory 1030 stores a charging rate, a charge level, and a queue of charging rates for a vehicle that is being charged. The memory 1030 can provide data related to the charging queue stored therein when the processor 1020 or the learning processor 1040 request to access to the data.

A model storage unit 1031 stores learning models (or artificial neural networks 1031a) that are being trained or have been trained by the learning processor 1040, and updated learning models in a case where existing learning models are updated through learning.

The model storage unit 1031 stores multiple versions of each learning model as necessary. That is, the versions are stored by learning level or time at which leaning is performed.

The artificial neural network 1031a illustrated in FIG. 2 is only an example artificial neural network including multiple hidden layers, but the present invention is not limited to the case where the learning model is an artificial neural network.

The artificial neural network 1031a is implemented in a hardware manner, a software manner, or a software/hardware combined manner. When a portion or the entirety of the artificial neural network 1031a is implemented in a software manner, one or more instructions that constitute the artificial neural network 1031a are stored in the memory 1030.

The storage unit 1050 stores programs and data necessary for operations of the charging controller 1000. The storage unit 1050 stores a program related to the programmed charging and transfers the program to the memory 1030 when the program is executed by the processor 1020.

The learning processor 1040 executes data mining, data analysis, intelligent decision making, and machine learning algorithms, and receives, classifies, saves, and outputs information to be used in the process of executing those schemes.

The learning processor 1040 includes a memory that is integrated with or implemented in the charging controller 1000. In some embodiments, the learning processor 1040 is implemented with the memory 1030.

Alternatively or additionally, the learning processor 1040 may be implemented with a memory associated with the charging controller 1000. The memory associated with the charging controller 1000 may be an external memory directly connected to the charging controller 1000 or a memory provided in a server that communicates with the charging controller 1000.

In other some embodiments, the learning processor 1040 may be implemented with a memory maintained in a cloud computing environment or a remotely positioned memory that can be accessed by the charging controller 1000 through a communication network.

The learning processor 1040 is configured to save data in one or more databases so that the data can be indexed, identified, categorized, manipulated, stored, retrieved, or outputted for various purposes. The databases may be used for supervised learning, unsupervised learning, data mining, predictive analysis, or other machining schemes.

The information stored in the learning processor 1040 can be used by the processor 1020 or other controllers to execute various data analysis algorithms and machine learning algorithms.

The learning processor 1040 trains the artificial neural network 1031a based on pre-processed data that is directly output from the processor 1020 that is configured to acquire data and to pre-process the acquired data, or based on pre-processed data retrieved from a database in which the pre-processed data is stored.

Artificial intelligence refers to an area of studying artificial intelligence or methodologies for creating it, and machine learning refers to an area of studying methodologies for defining problems and issues that are dealt in the field of artificial intelligence and for solving the problems. In another way, machine learning is also defined as an algorithm that constantly improves the performance of a specific task through experiences.

The artificial neural network is a model used in machine learning. It also refers to a set of models having a problem-solving ability, and each model is composed of artificial neurons (nodes) in a synaptic coupling network. The artificial neural network may be defined by a connection pattern between neurons in different layers, a learning process for updating model parameters, and an activation function that generates output values.

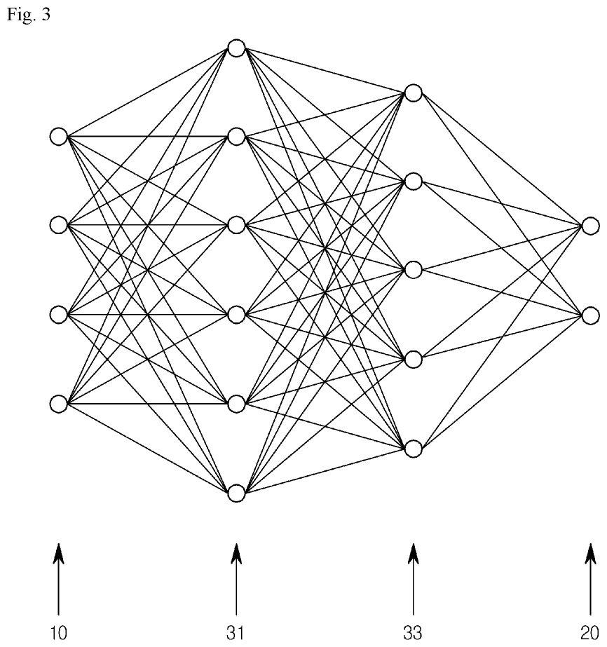

FIG. 3 is a view illustrating the structure of a fully-connected artificial neural network.

Referring to FIG. 3, the artificial neural network includes an input layer 10, an output layer 20, and optionally one or more hidden layers 31 and 33. Each layer includes one or more nodes corresponding to neurons of the neural network, and the artificial neural network includes synapses that connect nodes in one layer and nodes in another layer, respectively. In the artificial neural network, each node receives input signals through the synapses and generates output values using an activation function that uses bias and weights respective input signals. The output value of one node in a certain layer serves as an input signal that is input to one node in the next layer through synapses. An artificial neural network in which all nodes in one layer are connected to all nodes in the next layer, respectively, through synapses is referred to as a fully-connected artificial neural network.

Parameters of the artificial neural network model mean parameters determined through learning, and include weights for synaptic connections and bias of neurons. In addition, hyper-parameters mean parameters that should be set before learning in a machine learning algorithm, and include, for example, a learning rate, the number of iterations, a mini-batch size, and an initialization function.

Machine learning implemented as a deep neural network (DNN) including a plurality of hidden layers, among artificial neural networks, is also called deep learning. The deep learning is a class of machine learning. Hereinafter, when the term “machine learning” is used in the following description, it should be interpreted as including deep learning.

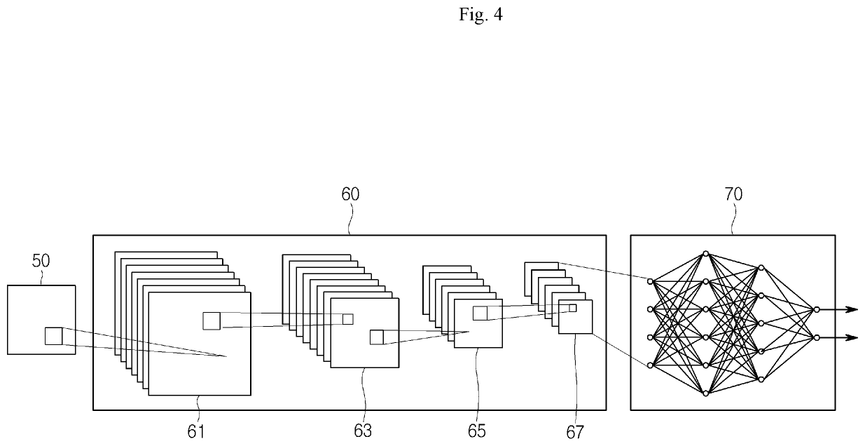

FIG. 4 is a view illustrating the structure of a convolutional neural network (CNN) that is a class of deep neural networks.

In a process of identifying structural spatial data, such as still images, moving images, and character strings, a convolutional neural network structure as illustrated in FIG. 4 is more effective. The convolutional neural network can effectively recognize features of adjacent images while maintaining spatial information of a specific image.

Referring to FIG. 4, the convolutional neural network includes a feature extraction layer 60 and a classification layer 70. The feature extraction layer 60 extracts features of a specific image by synthesizing images spatially close the specific image through a convolution process.

The feature extraction layer 60 is a multi-layer structure composed of convolutional layers 61 and 65 and pooling layers 63 and 67. The convolutional layers 61 and 65 are obtained by applying sequentially a filter and an activation function to input data. The convolutional layers 61 and 65 includes a plurality of channels, in which each channel may result from application of a different filter and/or a different activation function. The results of the convolutional layers 61 and 65 may be feature maps. The feature map is two-dimensional matrix data. The pooling layers 63 and 67 receive output data (e.g., feature maps) of the convolutional layers 61 and 65 as input data. The pooling layers 63 and 67 are used to reduce the size of the output data or to emphasize specific data. The pooling layers 63 and 67 generate output data using a max pooling function of selecting the largest value, a min pooling function of selecting the smallest value, or an average pooling function of selecting an average value, among some data of the output data of the convolution layers 61 and 65.

The feature map becomes smaller and smaller whenever passing through each of the convolutional layers and the pooling layers. The final feature map generated through the last convolutional layer and the last pooling layer has a one-dimensional form, and the one-dimensional feature map is input to the classification layer 70. The classification layer 70 is a fully-connected artificial neural network structure illustrated in FIG. 3. The number of input nodes of the classification layer 70 is equal to the number of channels multiplied by the number of elements of the matrix of the final feature map.

In addition to the convolutional neural network as a deep neural network structure, other artificial neural networks such as a recurrent neural network (RNN), a long short term memory network (LSTM), and a gated recurrent units (GRU) may be used. A circulatory neural network can perform classification or prediction through sequential learning from data. Since the circulatory neural network includes a cyclic structure inside thereof, past learning experience multiplied by a weight is reflected on the current learning process. Therefore, the current output is influenced by the past output, and the hidden layers function as a kind of memory. A circulatory neural network is used to perform machine translation by analyzing speech waveforms, to generate a text message by recognizing parts of words in a sentence, or to perform speech recognition.

The purpose of artificial neural network learning is to determine model parameters that can minimize a loss function. The loss function can be used as an index to determine an optimal model parameter in the learning process of an artificial neural network. In the case of a fully-connected artificial neural network, a weight of each synapse is determined through learning. On the other hand, in the case of a convolutional neural network, a filter for a convolutional layer is determined to extract a feature map through learning.

Machine learning can be categorized into supervised learning, unsupervised learning, and reinforcement learning according to a way of learning.

Supervised learning refers to a method of training an artificial neural network by using labels for training data. The label refers to a correct answer (or a result value) that needs to be produced by an artificial neural network given an input value. Unsupervised learning refers to a method of training an artificial neural network without labels for training data. Reinforcement learning refers to a learning method in which an agent defined in a certain environment is trained to select an action or a sequence of actions in a way to maximize a cumulative reward in each state.

When a request for vehicle charging is received from a new vehicle, a vehicle charging system according to one embodiment of the present invention proposes a charging condition such as a charge level to the user by using a charging learning model which is generated based on records of charging conditions used in past charging events.

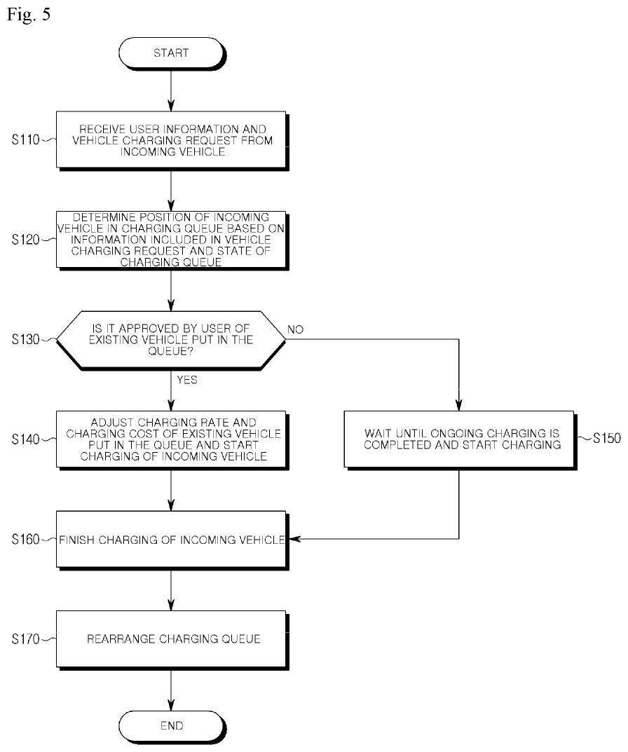

FIG. 5 is a flowchart illustrating a vehicle charging method according to one embodiment of the present invention.

Referring to FIG. 5, a vehicle charging method according to one embodiment of the present invention includes: receiving user information and a vehicle charging request from a first user of a first vehicle that has just arrived at step S110; putting a charging session of the first vehicle at a specific position in a charging queue, based on information contained in the vehicle charging request and a state of the charging queue at step S120; requesting a second user of a second vehicle to approve a specific charging event, the second vehicle being an electric vehicle that is put in the charging queue and is currently being charged at step S130; adjusting a charging rate and a charging cost for a charging session of the second vehicle and starting the charging session of the first user when the approval of the second user is obtained at step S140; waiting for stating of the charging session of the first vehicle until the charging of the second vehicle is completed when the approval of the second user is not obtained, and then starting the charging session of the first vehicle at Step 150; and re-arranging the charging queue at step S170 when the charging of the first vehicle is completed at step S160.

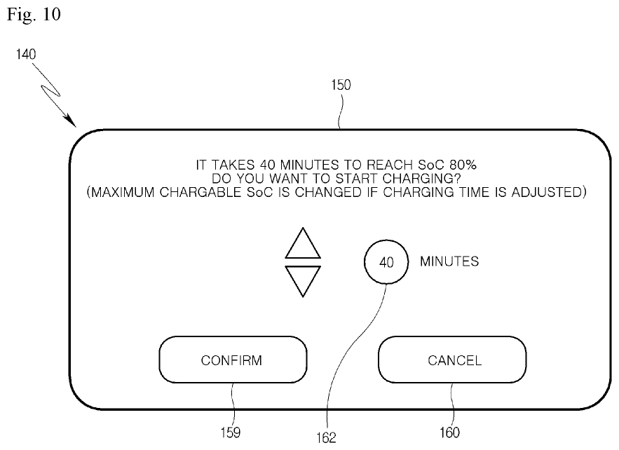

FIGS. 5 and 6 through 10 show sequential steps to be performed to offer vehicle charging service when a specific vehicle makes a request for vehicle charging service with respect to a vehicle charging system according to one embodiment of the present invention.

FIGS. 6 to 10 are views illustrating a charging condition setting menu for interactive charging. The menu is displayed on a display screen of a charging device included in a vehicle charging system according to one embodiment of the present invention.

Referring to FIG. 6, the vehicle charging system receives user information and a vehicle charging request from a user (herein after, referred to as a first user for convenience of description) of a first vehicle that has just arrived.

The first user of the first vehicle provides the system with user information and a vehicle charging request via a display unit 140 of a charging device 110 or any other input interface.

There may be a case where account information of the first user is retained in a storage unit 1050 of a charging controller 1000. The stored user account information includes records of charging conditions of past charging events and a learning model generated based on the records. When the user information is provided via the charging device 110, the charging controller 1000 reads the information out of the storage unit 1050 and loads the formation on the memory 1030.

The vehicle charging request contains information that is entered into dialog boxes 150 illustrated in FIGS. 6 to 10. First, referring to FIG. 6, the first user selects a charging service type among charging service types. In some embodiments, the charging service types include rapid charging, interactive charging, and standard charging (e.g., programmed charging) corresponding to command buttons 151, 152, and 153, respectively.

The rapid charging is a service type of charging an electric vehicle at a maximum power rate that can be provided by the charging device 110. This maximum power rate may be equal to a maximum power rate at or below which electric power can be delivered from the power supply equipment 100 to the charging devices 110 to 130. The rapid charging is provided at a highest charging cost.

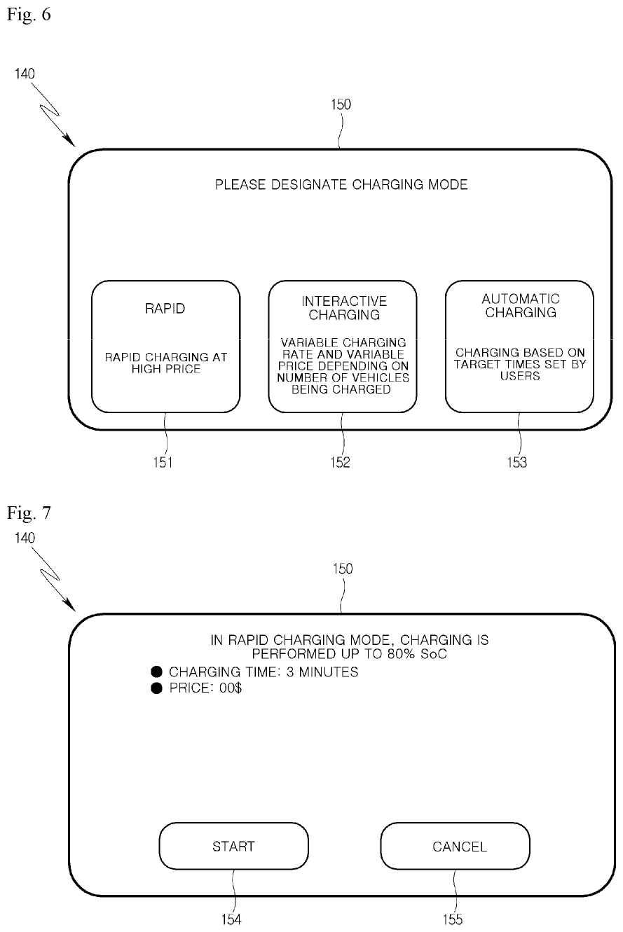

When selecting the rapid charging, the first user is informed of an estimated charging time and an estimated charging cost as illustrated in FIG. 7. The estimated charging time and cost are calculated based on the current state of charge (SoC) of the battery of the first vehicle. When the first user selects a “Charge” command button 154, a charging session of the first vehicle is started. On the other hand, when the user selects a “Cancel” command button 155, the display screen is switched back to the dialog box of FIG. 6.

In a case where the rapid charging is being performed for the first vehicle that is connected to the charging device 110, since the charging is performed at the maximum power rate, charging with the remaining charging devices 120 and 130 connected to the same power supply equipment 100 cannot be performed due to the lack of available power. Therefore, the remaining charging devices 120 and 130 are disabled while the charging with the charging device 110 is ongoing. In this case, the command buttons 151, 152, and 153 in the dialog box of FIG. 6 displayed on the screen of each of the charging devices 120 and 130 are disabled not to be selected by other users.

When the rapid charging is performed, the charging controller 1000 calculates the total amount of electric power to be delivered to the first vehicle to reach a designated charge level (e.g., target SoC) from the current charge level (current SoC) of the first vehicle, estimates a charging time and a charging cost required to reach the designated charge level, and present them to the first user by displaying the charging time and the charging cost on the display screen of the charging device 110. In the case of selecting the rapid charging as a service type, the charging controller 1000 does not use a charging learning model.

Next, a case where the interactive charging 152 is selected as a service type will be described. The interactive charging 152 is a service type in which vehicle charging is performed at a variable charging rate and a variable charging cost depending on the number of vehicles that are simultaneously charged from the same power supply equipment. When the user selects the interactive charging as a service type, the charging rate and the charging cost vary depending on the length of the queue for vehicle charging. That is, the charging rate and the charging cost vary depending on the number of vehicles that are being simultaneously charged and the number of vehicles that want to join the queue.

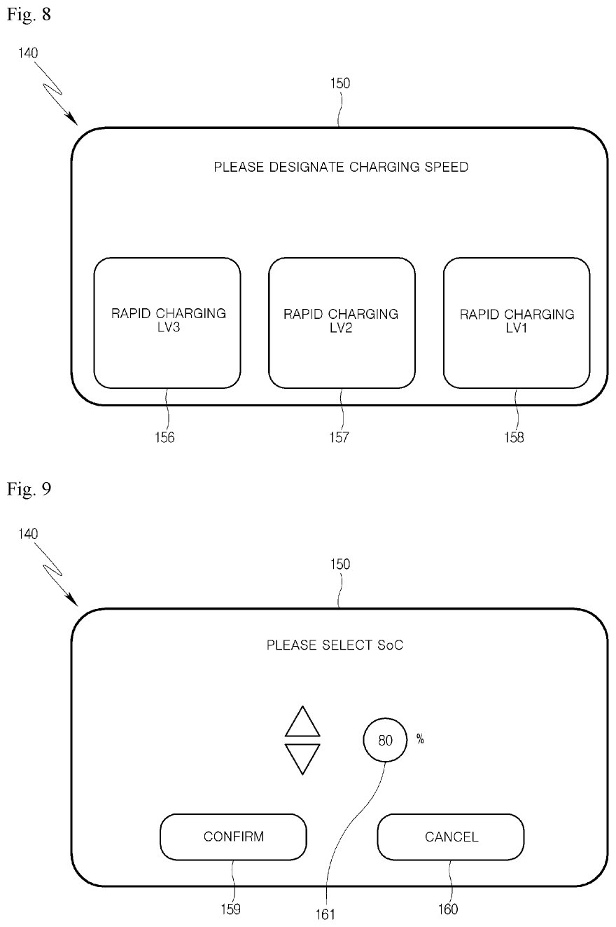

When the interactive charging 152 is selected, a user is prompted to provide detailed charging request information through the dialog boxes shown in FIGS. 8 and 9. When a user designates a charging rate by selecting any one command button from the dialog box of FIG. 8, that is, a user selects one charging rate among Level 1 charging 158, Level 2 charging, and Level 3 charging. The charging rate increases from Level 1 charging to Level 3 charging. The charging rate of Level 3 charging is the same as the charging rate of the rapid charging.

At least one of the command buttons 156, 157, and 158 indicating different charging rates may be disabled depending on the number of vehicles being charged with at least one of the charging devices 110, 120, and 130 connected to the same power supply equipment. For example, when there is one vehicle being charged with one of the charging devices 110, 120, and 130, the command button 156 indicating Level 3 charging may be disabled so that other uses cannot select the charging rate of Level 3 charging.

After a charging rate is designated, the user is prompted to designate a charge level 161 through the dialog box of FIG. 9. The charge level 161 is the state of charge (SoC) with respect to a full charge capacity of a vehicle battery. The charge level (e.g., SoC) 161 is measured in percentage points. After the charge level 161 is designated, the user is presented with the previous-stage dialog box or the next-stage dialog box depending on which command button is selected by the user, among a “Confirm” command button 159 and a “Cancel” command button 160.

When the user selects the “Confirm” command button 159, the charging controller 1000 puts the charging session of this user in the charging queue.

In the vehicle charging method according to one embodiment of the present invention, simultaneous charging of two or more electric vehicles is supported. That is, two or more charging devices connected to the same power supply equipment can be used for vehicle charging at the same time. In this case, approval of an earlier user is required. That is, for example, when a first vehicle is being charged with one charging device, the user of the first vehicle is requested to approve a simultaneous charging event (S130 of FIG. 5). When the approval is obtained, the simultaneous charging event in which the first vehicle and a second vehicle (e.g., the next vehicle in the queue) are simultaneously charged from the same power supply equipment can be started. In this case, the earlier user is given a benefit for the approval in a manner that a portion of the charging cost of the earlier user is billed to the user of the second vehicle.

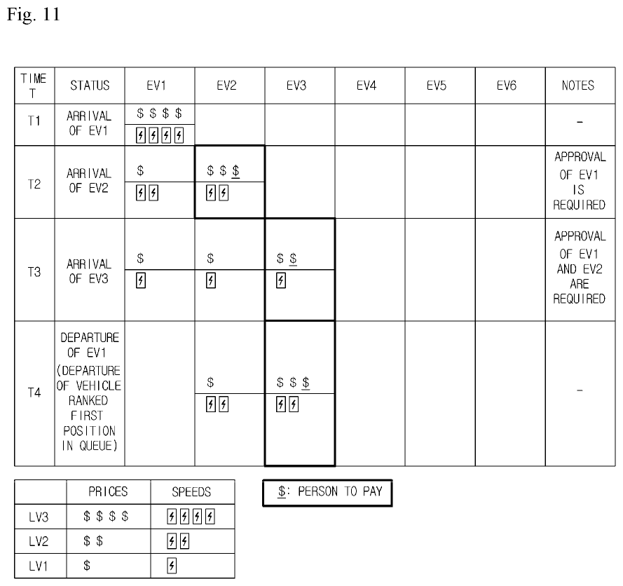

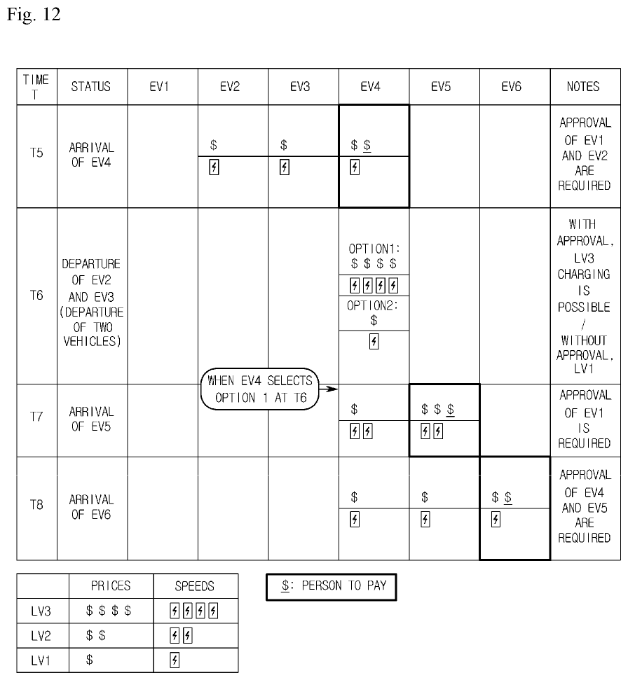

The process of obtaining an approval for simultaneous charging will be described below with reference to FIGS. 11 and 12.

FIGS. 11 and 12 are tables showing flow of vehicles in a vehicle charging system according to one embodiment of the present invention. FIG. 5 is also referred to for description of this process.

Referring to FIG. 11, at time T1, a first vehicle EV1 enters a vehicle charging system to receive a vehicle charging service. In FIGS. 11 and 12, it is assumed that interactive charging or standard charging (also called programmed charging) is selected as a service type.

It is assumed that a first vehicle EV1 is charged at a highest charging rate after designating interactive charging or standard charging as a service type and Level 3 charging as a charging rate. Since there are no other vehicles to join the queue for vehicle charging except for the first vehicle EV1, the charging is performed at the same charging rate as that provided by the rapid charging although Level 3 charging is designated. In this case, the charging cost is calculated with a highest rate (for example, four units per time) that is the same cost as the rapid charging.

At time t2, a second vehicle EV2 enters the vehicle charging system. It is assumed that an approval of the user of the first vehicle EV for simultaneous charging is obtained before the charging of the second vehicle EV2 is started. Since simultaneous charging is approved, the charging of the second vehicle EV2 can be started immediately without a wait time and performed at the same charging rate as that of the first vehicle EV1. The first vehicle EV1 is benefited for the approval such that a charging cost corresponding to one unit per time (of the four units per time) is paid by the second vehicle EV2 (refer to step S140 of FIG. 5). That is, from time T2, the first vehicle EV1 is charged at a charging rate of Level 2 and at a charging cost of one unit per time, and the second vehicle EV2 is charged at a charging rate of Level 2 and at a charging cost of three units per time. When the approval for simultaneous charging is not obtained from the first vehicle EV1, the second vehicle EV2 waits for vehicle charging service until vehicle charging of the first vehicle EV1 is completed (refer to step S150 of FIG. 5).

At time T3, a third vehicle EV3 enters the vehicle charging system. It is assumed that an approval of the first vehicle EV1 and an approval of the second vehicle EV2 for simultaneous charging are obtained before the vehicle charging of the third vehicle EV3 is started. Since simultaneous charging is approved, the charging of the third vehicle EV3 is immediately performed without a wait time at the same charging rate as that of the first vehicle EV1 and the second vehicle EV2.

In a case where only one of the first and second vehicles EV1 and EV2 gives an approval, charging of the third vehicle EV3 is performed at the same rate as that of the vehicle that has approved. That is, in a case where only the second vehicle EV2 gives an approval, the first vehicle EV1 is charged at a charging rate of Level 2 (that is, the charging rate is maintained), and the second and third vehicles EV2 and EV3 are charged at a charging rate of Level 1. In this case, a portion of the charging cost of the second vehicle EV2 is paid by the third vehicle EV3.

At time T4, since the charging of the first vehicle EV1 is completed, the charging queue is rearranged (refer to step S170 of FIG. 5). The charging of the third vehicle EV3 is started immediately and a portion of a charging cost of the second vehicle EV2 is billed to the third vehicle EV3.

Referring to FIG. 12, at time T5, a fourth vehicle EV4 enters the vehicle charging system and receives vehicle charging service. It is assumed that an approval of the second vehicle EV2 and an approval of the third vehicle EV3 for simultaneous charging are obtained before the charging of the fourth vehicle EV4 is started. Since simultaneous charging is approved, the charging of the fourth vehicle EV4 is immediately performed without a wait time at the same charging rate as that of the second vehicle EV2 and the third vehicle EV3.

At time T6, the charging of the second vehicle EV2 and the charging of the third vehicle EV3 are completed. At this time, the fourth vehicle EV4 is prompted to set a charging rate for the onward charging. That is, it is asked whether to switch to Level 2 or 3 charging or to maintain the current charging rate (e.g., Level 1 charging) for the onward charging.

It is assumed that the fourth vehicle EV4 designates Level 2 charging for the onward charging and a fifth vehicle EV5 enters the vehicle charging system. Before charging of the fifth vehicle EV5 is started, the fourth vehicle EV4 is requested to approve simultaneous charging. When the fourth vehicle EV4 approves simultaneous charging, the fourth vehicle EV4 and the fifth vehicle EV5 can be simultaneously charged. In this case, a portion of the charging cost of the fourth vehicle EV4 is billed to the fifth vehicle EV5.

At time T8, a sixth vehicle EV6 enters the vehicle charging system. As in the case of time T5, the fourth vehicle EV4, the fifth vehicle EV5, and the sixth vehicle EV6 are simultaneously charged when approvals are obtained from the fourth vehicle EV4 and the fifth vehicle EV5. In this case, a portion of the charging cost of the fourth vehicle EV4 and a portion of the charging cost of the fifth vehicle EV5 are billed to the sixth vehicle EV6.

The vehicle charging system queues electric vehicles in need of charging and determines a charging rate and a charging cost for each electric vehicle in the way described above. In addition, the vehicle charging system can create and refine a learning model for vehicle charging service by using the approvals and the command selections of the users as input data.

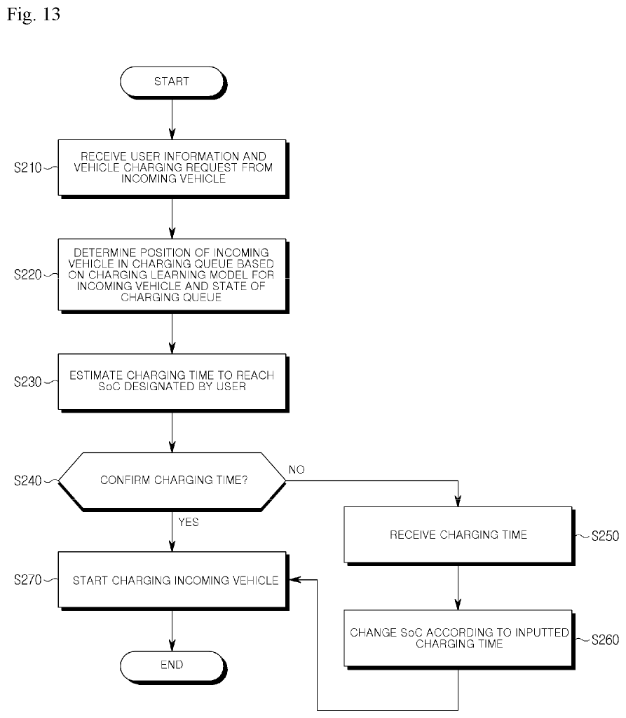

FIG. 13 is a flowchart illustrating a vehicle charging method in a case where standard charging is selected in a vehicle charging system according to one embodiment of the present invention.

Referring to FIG. 13, the method includes: a step S210 of receiving user information and a vehicle charging request from a first vehicle that has just arrived; a step S220 of putting the first vehicle in a charging queue while designating a position of the first vehicle in the charging queue, based on a charging learning model and a state of the charging queue; a step S230 of presenting an estimated charging time to reach a specific charge level set by a user of the first vehicle; a step 240 of asking a user whether to confirm the estimated charging time as a charging condition; a step S250 of receiving a user-setting charging time when the user does not confirm; a step S260 of changing the charging condition from the estimated charging time to the user-setting charging time; and a step S270 of starting charging of the first vehicle.

The charging controller 1000 creates a charging learning model based on records of past charging events related to the first vehicle and proposes a charging rate or a charge level as a charging condition by using the charging learning model.

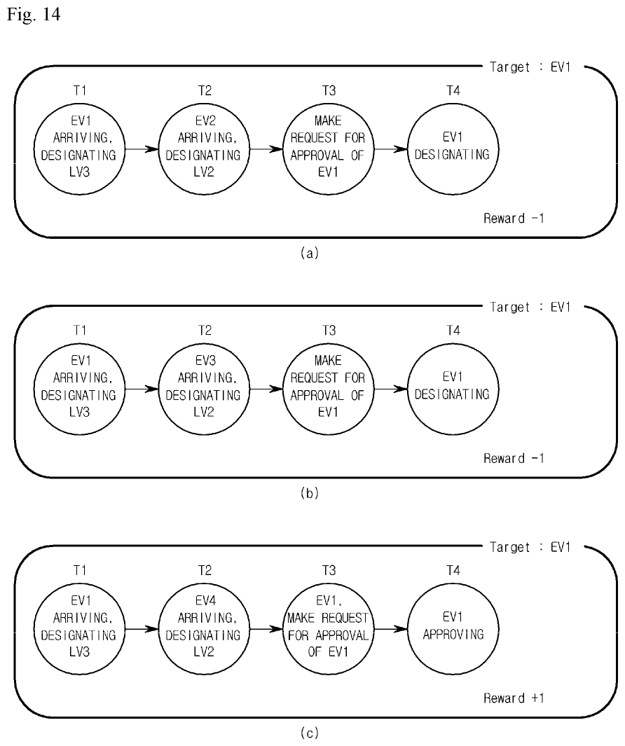

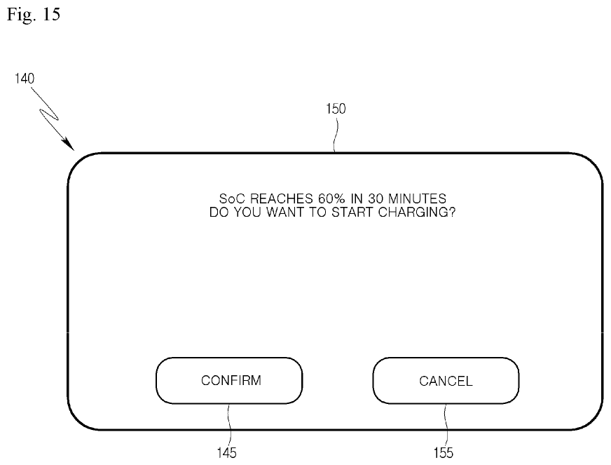

FIG. 14 is a view illustrating a process of creating a charging learning model in a vehicle charging system according to one embodiment of the present invention, and FIG. 15 is a display screen with a dialog box to receive information or commands from a user during creation of the charging learning model.

Referring to FIG. 14, the vehicle charging system includes an agent that defines a state of an environment composed of incoming vehicles and existing vehicles at each time T1, T2, T3, T4 and actions to be performed by the vehicles. The agent includes a program or codes of a program that is executed by the processor 1020 or the learning processor 1040 of the vehicle charging system.

The agent may request an incoming vehicle or an existing vehicle to select a specific command option or to approve a specific condition. The agent is given a different reward value depending on approval or disapproval of the user of each vehicle.

For example, it is assumed that a first vehicle EV1 enters the vehicle charging system and selects a charging speed of Level 3 at time T1 (refer to FIG. 14(a)) and a second vehicle EV2 enters the vehicle charging system and selects a charging speed of Level 2 at time T2. As described above, in order for two electric vehicles (e.g., the first vehicle and the second vehicle) connected to the same power supply equipment to be simultaneously charged, the approval of the first vehicle (e.g., existing vehicle) which is being charged is necessarily obtained.

It is also assumed that a third vehicle EV3 enters the vehicle charging system and requests the first vehicle EV1 to approve simultaneous charging (refer to FIG. 14(b)) and a fourth vehicle EV4 enters the vehicle charging system and requests the first vehicle EV1 to approve simultaneous charging (refer to FIG. 14(c)).

The request for approval for simultaneous charging is sent to the first vehicle EV1 at time T3, and a reward for an action (approval or disapproval) is provided to the agent at time T4. The agent reduces the reward when the first vehicle EV1 disapproves simultaneous charging (FIGS. 14(a) and 14(b)) but increases the reward when the first vehicle approves simultaneous charging (FIG. 14(c)).

In this manner, the agent can reduce or increase the reward by performing an action of receiving an answer (approval or disapproval) from the first vehicle that is being charged. The agent can select an action or a sequence of actions in a manner to maximize a cumulative sum of rewards. When an action is selected, the agent is provided with a new state of environment (e.g., a rearranged state of queue) resulting from the previous action and with a reward for the previous action.

The agent can reduce or increase the reward depending on the result (approval or disapproval) of the action. When a certain user designates standard charging (e.g., programmed charging) as a service type, as illustrated in FIG. 15, the charging controller 1000 suggests a specific charging rate and a specific charge level to the user (S230 of FIG. 13). The suggestion is provided based on a charging leaning model which is generated by the charging controller 1000.

When the user accepts the suggestion by pressing a “Confirm” button 145, the charging controller 1000 controls the charging device to perform vehicle charging according to the suggested charging condition and upgrades or refines the charging learning model. The charging controller 1000 may upgrade or refine the charging learning model in a manner to increase the reward for the action of the user.

On the other hand, when the user rejects the suggestion by pressing a “Cancel” button 155, the charging controller 1000 directly receives a specific charging rate and a specific charge level from the user via dialog boxes on the display screen shown in FIGS. 8 to 10. The charging controller 1000 may upgrade or refine the charging learning model in a manner to reduce the reward for the action of the user.

Reinforcement learning-based vehicle charging methods according to embodiments of the present invention can improve user satisfaction and convenience in vehicle charging by generating a learning model for EV charging service based on records of past charging events and proposing a user-specific charging condition including a charging rate and a charging level to a user.

The above-described present invention may be implemented as program codes recorded on a computer-readable recording medium. Examples of the computer-readable recording medium include all kinds of recording devices capable of retaining data that can be read by a computing system. Examples of the computer-readable recording medium includes hard disk drive (HDD), solid state disk (SSD), silicon disk drive (SDD), ROM, RAM, CD-ROM, magnetic tape, floppy disk, optical storage device, and the like. The computer may be equipped with the processor 180 that is provided in the terminal according to one embodiment of the present invention that has been described above.

While embodiments of the present invention have been described with reference to the accompanying drawings, those skilled in the art will appreciate that the present invention can be implemented in other different forms without departing from the technical spirit or essential characteristics of the embodiments. Therefore, it can be understood that the exemplary embodiments described above are only for illustrative purposes and are not restrictive in all aspects.

What is claimed is:

1. A method for reinforcement learning-based vehicle charging, the method comprising:
receiving a vehicle charging request from a second vehicle while a first vehicle already exists in a charging queue and is being charged;
in response to the vehicle charging request from the second vehicle, determining a charging condition of the second vehicle and determining a designated position for the second vehicle in the charging queue based on both a charging learning model generated based on records of past vehicle charging requests from the second vehicle and a charging condition of the first vehicle that is being charged; and
placing the second vehicle in the charging queue according to the designated position.

2. The method according to claim 1, wherein the receiving the vehicle charging request comprises:
receiving charging request information including a charging rate and a status of charging requested by the second vehicle.

3. The method according to claim 1, wherein the determining the charging condition of the second vehicle comprises:
requesting the first vehicle to approve a simultaneous charging event for simultaneously charging the first vehicle and the second vehicle; and
changing the charging condition of the first vehicle based on approval or disapproval of a user of the first vehicle.

4. The method according to claim 3, wherein the changing the charging condition of the first vehicle comprises:
setting a charging rate of the first vehicle to be equal to a charging rate of the second vehicle when the first vehicle approves the simultaneous charging event and billing a user of the second vehicle for a portion of a charging cost of the first vehicle.

5. The method according to claim 1, further comprising:
creating the charging learning model, wherein the creating of the charging learning model comprises:
defining, by an agent, a current state corresponding to the charging queue and an action of the first vehicle or the second vehicle included in the charging queue;
receiving, by the agent, a reward value that is increased or reduced according to the action; and
refining, by the agent, the charging learning model to maximize a cumulative sum of reward values for the first vehicle or the second vehicle.

6. The method according to claim 5, wherein the receiving the vehicle charging request from the second vehicle comprises:
determining an output data to be sent to a display screen based on the charging learning model;
displaying the output data on the display screen; and
receiving input data associated with the output data.

7. A computer program recorded on a non-transitory computer-readable recording medium, the computer program being executable by a computer to implement the method according to claim 1.

8. A system for reinforcement learning-based vehicle charging, comprising:
at least one charging device configured to connect to a vehicle;
power supply equipment configured to supply electric energy to the at least one charging device; and
a charging controller configured to:
control operation of the at least one charging device and operation of the power supply equipment,
receive a vehicle charging request from a second vehicle while a first vehicle already exists in a charging queue and is being charged by the power supply equipment,
in response to the vehicle charging request from the second vehicle, determine a charging condition of the second vehicle and determine a designated position for the second vehicle in the charging queue based on both a charging learning model generated based on records of past vehicle charging requests from the second vehicle and a charging condition of the first vehicle that is being charged, and
place the second vehicle in the charging queue according to the designated position.

9. The system according to claim 8, wherein the charging controller is further configured to:
receive charging request information including a charging rate and a status of charging requested by the second vehicle.

10. The system according to claim 8, wherein the charging controller is further configured to:
request the first vehicle to approve a simultaneous charging event for simultaneously charging the first vehicle and the second vehicle, and
change the charging condition of the first vehicle based on approval or disapproval of a user of the first vehicle.

11. The system according to claim 10, wherein the charging controller is further configured to:
set a charging rate of the first vehicle to be equal to a charging rate of the second vehicle when the first vehicle approves the simultaneous charging event and bill a user of the second vehicle for a portion of a charging cost of the first vehicle.

12. The system according to claim 8, wherein the charging controller is further configured to:
allow an agent to define a current state corresponding to the charging queue and an action of the first vehicle or the second vehicle included in the charging queue,
allow the agent to receive a reward value that is increased or reduced according to the action, and
allow the agent to refine the charging learning model to maximize a cumulative sum of reward values for the first vehicle or the second vehicle.

13. The system according to claim 12, wherein the charging controller is further configured to:
determine an output data to be sent to a display screen based on the charging learning model,
control the display screen to display the output data, and
receive input data associated with the output data.

14. A device for reinforcement learning-based vehicle charging, comprising:
a communication interface configured to communicate with power supply equipment for charging a vehicle; and
a controller configured to:
receive a vehicle charging request from a second vehicle while a first vehicle already exists in a charging queue and is being charged by the power supply equipment,
in response to the vehicle charging request from the second vehicle, determine a charging condition of the second vehicle and determine a designated position for the second vehicle in the charging queue based on both a charging learning model generated based on records of past vehicle charging requests from the second vehicle and a charging condition of the first vehicle that is being charged, and
place the second vehicle in the charging queue according to the designated position.

15. The device according to claim 14, wherein the controller is further configured to:
receive charging request information including a charging rate and a status of charging requested by the second vehicle.

16. The device according to claim 14, wherein the controller is further configured to:
in response to receiving the vehicle charging request from the second vehicle, transmit a request to the first vehicle to approve a simultaneous charging event for simultaneously charging the first vehicle and the second vehicle, and
in response to receiving approval of the simultaneous charging event from the first vehicle, change the charging condition of the first vehicle based on the approval.

17. The device according to claim 16, wherein the controller is further configured to:
set a charging rate of the first vehicle to be equal to a charging rate of the second vehicle when the first vehicle approves the simultaneous charging event and bill a user of the second vehicle for a portion of a charging cost associated with charging the first vehicle.

18. The device according to claim 17, wherein the controller is further configured to:
in response to receiving a vehicle charging request from a third vehicle while the first and second vehicles are being charged, transmit a request to the first vehicle to approve a simultaneous charging event for simultaneously charging the first, second and third vehicles and transmit a request to the second vehicle to approve the simultaneous charging event for simultaneously charging the first, second and third vehicles.

19. The device according to claim 18, wherein the controller is further configured to:
in response to receiving approval of the simultaneous charging event from both of the first vehicle and the second vehicle, change charging conditions of the first and second vehicles, begin charging the third vehicle, and bill a user of the third vehicle a portion of a charging cost associated with charging the first and second vehicles.

20. The device according to claim 14, wherein the controller is further configured to:
define a current state corresponding to the charging queue and an action of the first vehicle or the second vehicle included in the charging queue,
increase or decrease a reward value according to the action, and
update the charging learning model to maximize a cumulative sum of reward values for the first vehicle or the second vehicle.
